(19) United States
(12) Patent Application Publication
(10) Pub. No.: US 2026/0349996 A1
(43) Pub. Date: Nov. 5, 2026

(54) AI-POWERED AUTOMATED CREATION OF ANALYTICAL QUERIES

(71) Applicant: SAP SE, Walldorf (DE)

(72) Inventors: Sai Sunanda D, Hyderabad (IN); Sanjay S, Bangalore (IN); Aneesh Shukla, Delhi (IN); Vignesh Sankaran, Bangalore (IN)

(73) Assignee: SAP SE, Walldorf (DE)

(21) Appl. No.: 19/194,436

(22) Filed: Apr. 30, 2025

(51) Int. Cl. G06F 16/242; G06F 16/2455; G06F 16/2457

(52) U.S. Cl. CPC G06F 16/243; G06F 16/24564; G06F 16/24573

(57) ABSTRACT

A computer-implemented method for automatically generating an analytical query in a proprietary analytics platform using a trained artificial intelligence model is disclosed. The method comprises receiving a user request in natural language from a user interface; generating an intent map based on natural language processing of the user request; enriching the intent map based on metadata of a database to produce an enriched intent map; mapping the user intent to an action list based on predefined rules stored in an action library, wherein the action list defines query operations specific to the proprietary analytics platform; and constructing the analytical query based on the action list, wherein execution of the analytical query generates an output responsive to the user request. Related systems and software for implementing the method are also disclosed.

### BACKGROUND

Analytics queries, sometimes referred to as business analytics queries, are structured requests that retrieve, aggregate, and analyze data from databases to support decision-making processes. Analytics queries are commonly used in analytics platforms to generate reports, dashboards, and insights that drive business operations. Although many analytics platforms provide proprietary query generation interfaces to simplify query construction, building sophisticated analytical queries still requires users to manually apply filters, define calculated fields, and validate data selections against metadata rules. This manual process can be complex, error-prone, and time-consuming, especially when users must adapt queries based on evolving analytical needs. Despite improvements to user interfaces, constructing and refining analytical queries often demands significant expertise and effort, creating inefficiencies and limiting accessibility for non-technical users. Thus, there is room for improvement in facilitating more efficient, accurate, and accessible construction of analytical queries within proprietary analytics platforms.

### BRIEF DESCRIPTION OF THE DRAWINGS

FIG. 1 is a block diagram depicting an example computing system for automated creation of analytical queries powered by artificial intelligence (AI).

FIG. 2 is a flowchart illustrating an example overall method for implementing AI-powered automated creation of analytical queries.

FIG. 3 is a sequence diagram illustrating an example workflow for automatically generating an analytical query responsive to a user request.

FIG. 4 is a sequence diagram illustrating an example workflow for incorporating a preliminary query in automatic generation of an analytical query.

FIG. 5 is a sequence diagram illustrating an example workflow for modifying an automatically generated analytical query.

FIG. 6 is a block diagram of an example computing system in which described embodiments can be implemented.

FIG. 7 is a block diagram of an example cloud computing environment that can be used in conjunction with the technologies described herein.

### DETAILED DESCRIPTION

### Example Overview of Analytical Query Generation

Analytics queries are structured requests formulated to retrieve, aggregate, filter, and analyze data from one or more databases. Analytics queries enable organizations to transform raw data into meaningful insights used for business decision-making, operational monitoring, and strategic planning. Within analytics platforms, these queries drive the generation of reports, dashboards, visualizations, and ad-hoc analyses. Analytics queries may vary in complexity, from simple queries requesting basic counts or sums to highly sophisticated queries involving calculated measures, multi-level groupings, advanced filters, and validation constraints across multiple datasets. To facilitate broader user access to these capabilities, many analytics platforms offer proprietary query generation interfaces that allow users to build queries through graphical or menu-driven interactions without writing raw code, e.g., using Structured Query Language (SQL) or the like.

Despite the advancements in user interfaces, constructing analytical queries using these proprietary systems remains a technically demanding and error-prone process. Users must often navigate complex options, manually configure filters, define calculated columns, establish relationships among data fields, and apply validations. In many cases, building an effective analytical query requires an understanding of not only the platform's query generation tools but also the underlying business metadata, such as field types, hierarchies, and calculation rules. Errors in constructing analytical queries, such as selecting the wrong dimensions, applying incorrect aggregation formulas, or failing to align with data governance rules, can result in inaccurate outputs, operational delays, or compliance risks.

Furthermore, conventional query building workflows are often inflexible when evolving analytical needs arise. Modifications such as adding new filters, adjusting grouping criteria, or introducing additional calculated fields frequently require significant manual intervention. Users must reconstruct large portions of the analytical query or restart the workflow entirely. This lack of adaptability not only increases the time and resource required to generate meaningful results but also imposes barriers for non-technical users who may lack deep expertise in analytical query generation processes or the underlying business data models. Consequently, these technical challenges limit the speed, accuracy, and accessibility of data-driven decision-making across organizations.

The technologies described herein address many of the challenges described above by enabling AI-powered, metadata-driven automation of the analytical query generation process within proprietary analytics platforms. By leveraging structured mappings between user analytical intents and platform-specific query operations, and by dynamically constructing and validating queries in runtime, the disclosed technologies facilitate more efficient, accurate, and accessible construction, refinement, and execution of analytical queries.

### Example Computing System for Automated Generation of Analytical Queries

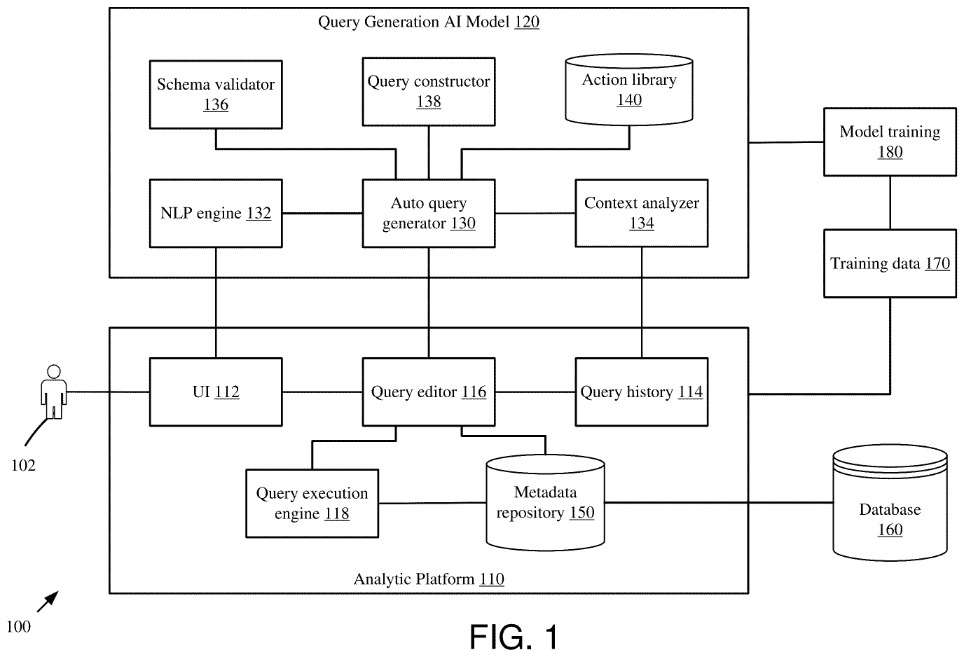

FIG. 1 shows an overall block diagram of an example computing system 100 supporting AI-powered automated generation of analytical queries for a proprietary analytic platform 110. The computing system 100 is configured to respond to a user request to automatically generate, in runtime, an analytical query that is compatible with the proprietary analytic platform 110. When executed on the analytic platform 110, the analytic query can generate an output responsive to the user request.

As shown, the analytic platform 110 provides a user interface (UI) 112 through which a user 102 can submit a user request in natural language, and interact with various tools of the analytic platform 110. For instance, through the UI 112, the user 102 can manually construct and view the structure of an analytical query that is specific to the analytic platform 110. Through the UI 112, the user 102 can also execute an analytical query against a database 160 and generate a report summarizing the query results. As described herein, the database 160 may store structured and/or unstructured data in various formats and support analytical operations such as aggregations, filtering, and ranking based on the incoming queries. Additionally, through the UI 112, the user 102 can review metadata or schema of the database 160 which defines the organization, relationships, and attributes of the data to be retrieved, aggregated, and/or analyzed by the analytical queries.

The analytic platform 110 further includes a query editor 116, which provides an interface through which the user 102 can manually construct, edit, and view analytical queries. In some examples, the query editor 116 can be part of the UI 112. The query editor 116 can present various interactive controls that allow the user 102 to define the structure and logic of an analytical query without manually writing database query code. These controls may include selectable lists of fields, dropdown menus for selecting aggregation functions, graphical tools for setting filter conditions, and formula builders for creating calculated fields. Through the query editor 116, the user 102 can specify one or more measures to be calculated, one or more dimensions for grouping or categorization, and one or more filters for restricting the data retrieved from the database 160. The query editor 116 can also allow the user 102 to review the structure of a fully or partially constructed analytical query, make modifications, and validate selections against available metadata.

In some examples, the metadata or schema of the database 160 can be stored in a metadata repository 150, which can be part of the analytic platform 110. The stored metadata can include definitions of measures, dimensions, field types, relationships between tables, allowed aggregations, calculation rules, or the like. During manual construction of analytical queries via the query editor 116, the user 102 can consult the metadata repository 150 to verify field selections, validate data types, and understand permissible operations so that the analytical queries constructed through the analytic platform 110 are semantically correct and executable within the platform's environment.

The analytic platform 110 also includes a query execution engine 118, which can execute the analytical queries, which can be constructed either manually (e.g., using the query editor 116) or automatically, as described more fully below. In some examples, the query execution engine 118 can convert the analytical queries into executable code, such as SQL statements or other database-specific query instructions. The query execution engine 118 can retrieve the requested data from the database 160, and deliver the corresponding output (e.g., a report, a dashboard, etc.) to the user 102 via the UI 112.

In some examples, the analytic platform 110 may also include a query history module 114, which records historical analytical queries generated or edited by the user 102. The query history module 114 can optionally capture step-by-step actions the user 102 took during manual query creation, including field selections, filter additions, and calculation definitions. In some examples, the query history module 114 can also record user queries entered in natural language (e.g., through the UI 112) during the automated query generation process. Information stored in the query history module 114 can later be used to support context-aware enhancements during future automated query generation sessions, as described further below.

As shown in FIG. 1, the computing system 100 includes a query generation AI model 120, or simply “AI model,” which is responsible for automating the analytical query generation process. As described below, the AI model 120 can receive the user request expressed in natural language, process the user request using artificial intelligence techniques, and automatically generate, in runtime, a complete analytical query suitable for execution by the analytic platform 110.

The AI model 120 can be pretrained using a model training unit 180, as described further below. In some examples, the AI model 120 includes a natural language processing (NLP) engine 132 configured to process the natural language user request received from the UI 112. The NLP engine 132 may be implemented as a machine learning model trained during the training process, for example, by the model training unit 180. The NLP engine 132 may use various techniques, such as transformer-based deep learning models, sequence-to-sequence models, named entity recognition models, rule-based natural language parsing, or hybrid approaches combining machine learning and rule-based grammar systems. The NLP engine 132 is configured to extract key components from the user request, such as user intent, requested measures, filters, grouping dimensions, and identified parameters relevant to the query construction.

The AI model 120 can include an auto query generator 130 coordinating the overall process of automated query generation by orchestrating interactions among various components of the AI model 120. As described below, the auto query generator 130 can be configured to centrally manage the sequential steps required to translate the user intent into an executable analytical query, following a chain-of-thoughts approach where interim reasoning and intermediate structures, such as intent maps and action lists, are progressively refined before final query construction. In some examples, the auto query generator 130 can reference predefined mappings stored in an action library 140 to map the user intent extracted from the user request (e.g., by the NLP engine 132) to an action list. The action list can specify a series of actions that define query operations compatible with the proprietary analytics platform 110, such as adding filters, selecting measures, grouping dimensions, and creating calculated fields, etc.

In some examples, the AI model 120 can optionally include a context analyzer 134, which can be configured to enhance the quality and relevance of the generated analytical queries by retrieving information stored in the query history module 114. Specifically, the context analyzer 134 can retrieve previous user queries, user preferences, or prior selections to refine the interpretation of the current user request. Contextual information can be particularly valuable for disambiguating user intents, suggesting likely filters, and/or pre-filling measures commonly used by the user 102.

In some examples, the action library 140 can be maintained within the AI model 120. The action library 140 can store predefined mappings between user intents and corresponding actions, where each action specifies one or more query operations compatible with the proprietary analytics platform 110. These mappings can be based on user interactions observed across the analytic platform 110, including natural language user queries entered through the UI 112 and the manual query-building actions taken by the user (e.g., through the query editor 116). In some examples, these predefined mappings can be organized as structured rules that the auto query generator 130 can reference to map extracted user intents to a corresponding action list. The generated action list provides an intermediate, structured representation of the analytical query that captures the sequence and types of operations to be performed during query execution.

The AI model 120 further includes a schema validator 136 that ensures any generated analytical query conforms to metadata constraints defined in the metadata repository 150 and satisfies syntax and semantic requirements of the proprietary analytics platform 110. For example, the schema validator 136 can validate the analytical query against the metadata repository 150 by verifying field existence, confirming valid data types, and ensuring that aggregation rules are properly applied. In addition, the schema validator 136 can validate the analytical query against the syntax and semantic requirements of the analytic platform 110, including verifying that formulas or expressions used within measures and calculated fields are properly structured and logically consistent for execution within the platform environment.

In some examples, the AI model 120 can include a query constructor 138 which is configured to assemble the final analytical query. The query constructor 138 can take as input the action list generated through prior processing steps and convert it into a complete analytical query in the format or query language required by the analytic platform 110. In some examples, the query constructor 138 may support generation of SQL-based queries, proprietary query expressions, or structured payloads formatted in JSON, XML, or the like.

In some examples, the AI model 120 can also be configured to generate an explanation of the assembled analytical query and present the explanation to the user 102 via the UI 112. The explanation can include a description of the key actions taken during query generation, such as measures selected, filters applied, grouping dimensions specified, and formulas used for calculated fields. Providing explanations can improve user trust, help users verify that the generated query aligns with their analytical intent, and assist users in learning how queries are constructed within the analytic platform 110. Various techniques can be used to generate query explanations, such as rule-based template generation (e.g., mapping actions to predefined natural language templates), generative AI models trained on query-action pairs to produce natural language explanations, or chain-of-thought reasoning outputs captured during intermediate processing stages. In some examples, the explanation may be generated based on the actual action list and metadata context to ensure that the presented explanation accurately reflects the specific analytical query constructed for the user request.

The computing system 100 can also include a model training unit 180 configured to train or fine-tune components of the query generation AI model 120. The model training unit 180 utilizes training data 170, which may include logs of user interactions with the UI 112, historical analytical queries (e.g., stored in the query history module 114), and system-generated mappings between user intents and query operations (e.g., mappings supplied by the provider of the analytic platform 110). In some examples, the training data 170 may be collected from ongoing usage of the analytic platform 110.

The model training unit 180 can implement various machine learning techniques depending on the component being trained. In some examples, supervised learning techniques can be used, where labeled training data pairs user requests with corresponding structured queries or action sequences. In other examples, reinforcement learning techniques can be employed, where the AI model 120 learns to generate improved queries based on feedback signals reflecting query execution success or output quality. In certain cases, rule-based training approaches can also be applied to create or update structured mappings in the action library 140, e.g., using predefined rules extracted from user interaction patterns or system specifications.

In some examples, different components of the AI model 120 can be trained using different training methods. For instance, the NLP engine 132 may be trained primarily using supervised learning with annotated user queries, while the action library 140 may be expanded or refined through rule-based training. The auto query generator 130 can be trained or fine-tuned using either supervised or reinforcement learning to improve its mapping of user intents to coherent and executable action lists. The model training unit 180 thus provides flexible training strategies tailored to the specific functional requirements of each component of the AI model 120, enabling continuous improvement, adaptation to evolving user behaviors, and alignment with updates to the analytic platform's metadata schema or query generation interface.

The described system 100 can be networked via wired or wireless network connections, including the Internet. Alternatively, the system 100 can be connected through an intranet connection.

The systems 100 and any of the other systems described herein can be implemented in conjunction with any of the hardware components described herein, such as the computing systems described below (e.g., processing units, memory, and the like). In any of the examples herein, user requests, analytical queries, action lists, metadata, mappings, and the like can be stored in one or more computer-readable storage media or computer-readable storage devices. The technologies described herein can be generic to the specifics of operating systems or hardware and can be applied in any variety of environments to take advantage of the described features.

### Example Overall Method for Automated Analytica Query Generation

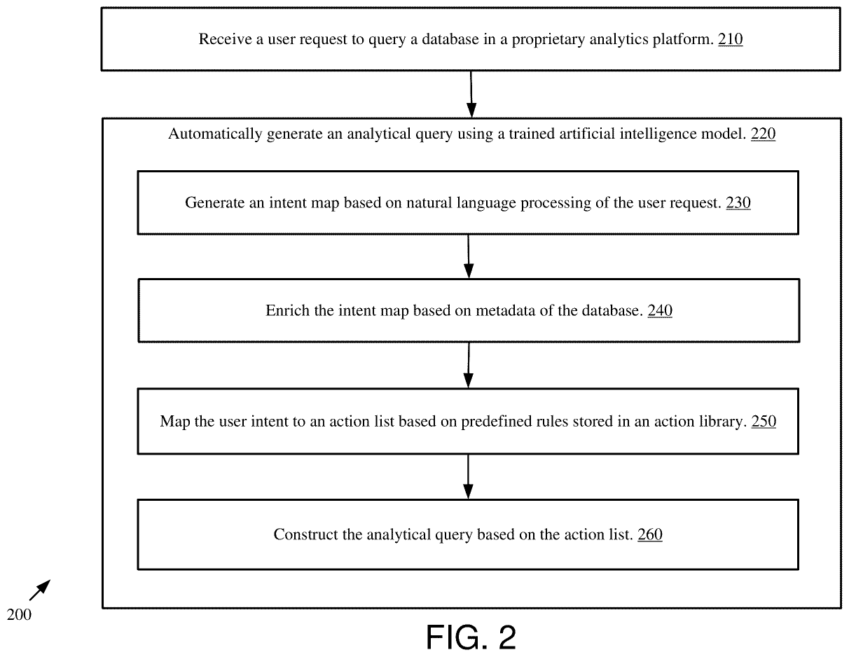

FIG. 2 is a flowchart describing an overall method 200 for implementing AI-powered automated generation of analytical queries. The method 200 can be implemented, for example, by the computing system 100 of FIG. 1.

At step 210, the method can receive, from a user interface (e.g., 112) of a proprietary analytics platform (e.g., 110), a user request in natural language for querying a database (e.g., 160).

At step 220, the method can automatically generate an analytical query using a trained AI model (e.g. 120). The step 220 can include a sequence of steps below.

At step 230, the method can generate, in runtime, an intent map based on natural language processing of the user request (e.g., using the NLP engine 132). The intent map can include a user intent and one or more measures extracted from the user request.

At step 240, the method can enrich, in runtime, the intent map based on metadata of the database (e.g., stored in the metadata repository 150), to generate an enriched intent map comprising at least one inferred formula for calculating a measure extracted from the user request.

At step 250, the method can map, in runtime, the user intent to an action list based on predefined rules stored in an action library (e.g., 140). The action list comprises one or more actions derived from the enriched intent map. The one or more actions define query operations specific to the proprietary analytics platform.

Then at step 260, the method can construct, in runtime, the analytical query based on the action list.

As described herein, execution of the analytical query on the proprietary analytics platform can generate an output responsive to the user request based on calculation of the measure using the at least one inferred formula.

In some examples, the step 220 further includes retrieving (e.g., by the context analyzer 134), in runtime, a user history (e.g., from the query history module 114) associated with the user request. The user history comprises one or more historical queries previously generated based on prior user requests. The method can then identify, in runtime, a query refinement related to the user intent from the user history, and refine, in runtime, the action list based on the query refinement. In some examples, refining the action list comprises adding a new action to the action list or modifying an existing action in the action list. As such, constructing the analytical query can be based on the refined action list.

The step 260 can further include one or more sub-steps. For example, constructing the analytical query can include selecting one or more output fields based on the user intent, wherein the one or more output fields comprise the one or more measures, and further comprise one or more dimensions or one or more calculated columns identified in the action list. The method can further validate the one or more output fields against the metadata of the database to ensure that each output field corresponds to a valid field defined in the metadata.

In some examples, constructing the analytical query includes applying one or more filters identified in the action list to the analytical query, wherein each filter specifies a field and an associated filter value. The method can further validate the one or more filters against the metadata of the database to ensure that each field specified in the one or more filters exists in the metadata and that each associated filter value conforms to a data type defined in the metadata.

In some examples, constructing the analytical query includes defining a grouping plan for the analytical query based on one or more dimensions identified in the action list, wherein the grouping plan specifies an order of the one or more dimensions and an aggregation mode. The method can further validate the grouping plan against the metadata of the database to ensure that each dimension specified in the grouping plan exists in the metadata and that the aggregation mode is compatible with the metadata.

In some examples, constructing the analytical query includes constructing a metric payload comprising the one or more measures identified in the action list, wherein each measure is calculated by a corresponding formula. The method can further validate the metric payload against the metadata of the database to ensure that each field referenced in each corresponding formula exists in the metadata and that each formula conforms to syntax rules defined by the proprietary analytics platform.

In some examples, constructing the analytical query includes adding one or more calculated fields to the analytical query based on the user intent, wherein each calculated field includes a name and an associated calculation expression. The method can further validate the one or more calculated fields against the metadata of the database to ensure that each field referenced in each calculation expression exists in the metadata and that each calculation expression conforms to syntax rules defined by the proprietary analytics platform.

In some examples, the method 200 can further support interactive modification or optimization of the generated analytical query. For example, the method can receive, from the user interface, a subsequent user request. Responsive to the subsequent user request, the method can automatically update the analytical query to a modified analytical query using the trained AI model. Updating the analytical query can include a sequence of steps. For example, the method can extract, in runtime, a new user intent from the subsequent user request using natural language processing (e.g., by the NLP engine 132). In some examples, the new user intent indicates adding a new filter. The method can update, in runtime, the intent map to include the new user intent. Then, the method can map, in runtime, the new user intent to one or more additional actions using predefined rules stored in the action library. The one or more additional actions define a query operation for adding the new filter. Subsequently, the method can update, in runtime, the action list based on the one or more additional actions, and construct, in runtime, the modified analytical query based on the updated action list.

In some examples, the step 220 for automatically generating the analytical query can include the following preprocessing steps before constructing the analytical query. First, the method can identify, in runtime, based on the user intent, a refinement condition for refining a dataset prior to constructing the analytical query. The method can generate, in runtime, a preliminary query based on the user intent and the metadata of the database. The preliminary query is configured to generate a refined dataset for use in constructing the analytical query. The method can then update, in runtime, the action list to incorporate a reference to the preliminary query as a data source for constructing the analytical query. The method can further validate, in runtime, the analytical query to ensure compliance with syntax rules and metadata constraints of the proprietary analytics platform.

In some examples, the method 200 can further include training the AI model (e.g., using the model training unit 180), including various components of the AI model. The training can include collecting training data (e.g., 170) comprising user actions performed through the user interface of the proprietary analytics platform and corresponding query operations. Each user action comprises a natural language expression or a user interface interaction and is associated with one or more query operations compatible with the proprietary analytics platform. The training can generate, based on the training data, an action library comprising a plurality of predefined rules that map user intents, derived from the user actions, to corresponding actions, wherein each action defines at least one query operation. The AI model can be trained using the action library as input to learn mappings from user intents to actions.

The method 200 and any of the other methods described herein can be performed by computer-executable instructions (e.g., causing a computing system to perform the method) stored in one or more computer-readable media (e.g., storage or other tangible media) or stored in one or more computer-readable storage devices. Such methods can be performed in software, firmware, hardware, or combinations thereof. Such methods can be performed at least in part by a computing system (e.g., one or more computing devices).

The illustrated actions can be described from alternative perspectives while still implementing the technologies. For example, “send” can also be described as “receive” from a different perspective.

### Example Intent Maps

As described above, an intent map can be generated in runtime based on natural language processing of a user request received through a user interface (e.g., UI 112). As described herein, an intent map provides a structured intermediate representation of the user request, capturing the user's analytical intent in a machine-readable format that facilitates the subsequent generation of an analytical query. An intent map may include various fields representing different aspects of the intended analysis, such as measures, dimensions, filters, grouping criteria, time frames, calculated fields, and/or aggregation types.

As a first example, a user may submit a request such as: “Analyze the profitability and sales growth for sneakers, boots, and jackets in the Footwear and Outerwear categories, filtered by premium brands and the North America region, with a calculated column for profit margin percentage, grouped by product category and year.” The AI model can process this user request (e.g., through the NLP engine 132) and generate an intent map (represented in JSON format) as follows:

### Listing 1: An Example Intent Map.

```
{
“intent”: “analysis”,
  “measures”: [“profitability”, “sales_growth”],
  “calculated_columns”: [
    {
      “name”: “profit_margin_percentage”,
      “type”: “percentage”
    }
  ],
  “products”: [“sneakers”, “boots”, “jackets”],
  “categories”: [“Footwear”, “Outerwear”],
  “filters”: [
    {
      “field”: “BrandType”,
      “value”: “premium”
    },
    {
      “field”: “Region”,
      “value”: “North America”
    }
  ],
  “dimensions”: [“Category”, “Year”]
}
```

As a second example, a user may submit a request such as: “Show total sales and number of transactions for the top 5 regions in the past year.” The NLP engine can process this request and generate an intent map such as:

Listing 2: Another example intent map.

```
{
  “intent”: “analysis”,
  “measures”: [“total_sales”, “transaction_count”],
  “dimensions”: [“region”],
  “filters”: [
    {
      “field”: “year”,
      “value”: “last_year”
    }
  ],
  “ranking”: {
    “field”: “total_sales”,
    “top_n”: 5,
    “order”: “desc”
  }
}
```

Each field of the intent map provides specific information which can be useful for constructing the analytical query. For example, the “intent” field specifies the overall type or intent of analytical operation requested. The “measures” field identifies the key metrics to be calculated. The “calculated_columns” field defines user-requested derived fields which may not exist in the database (e.g., not present in existing columns of database tables). The “products” and “categories” fields can respectively specify product and category filters the user wants to apply. The “filters” field can include explicit constraints mentioned in the request, while the “dimensions” field can indicate how the results should be grouped and/or how the measures should be aggregated. The “ranking” field can specify additional logic for sorting and limiting the query results. These extracted fields collectively provide the structural foundation for generating corresponding actions during query construction.

As described above, the NLP engine can be trained (e.g., by the model training unit 180) to extract these fields from diverse natural language expressions. In some examples, supervised learning techniques can be used, where the NLP engine is trained on annotated datasets containing user requests paired with corresponding intent maps. Named entity recognition models may be employed to detect specific field names, product names, metric names, and filter values. Transformer-based models, sequence-to-sequence models, or hybrid systems combining machine learning and rule-based parsing approaches can also be used to improve extraction accuracy.

It should be understood that not all fields may be present in every user request. For example, a user request may specify measures and dimensions but without ranking criteria or calculated columns. In such cases, the generated intent map may initially contain only a subset of fields. In some examples, additional missing information can be inferred during a subsequent phases, for example, by referencing metadata from the metadata repository (e.g., 150) and/or leveraging contextual insights retrieved by the context analyzer (e.g., 134).

### Example Metadata Integration

After generating an initial intent map from the user request, the AI model can dynamically integrate business metadata to enrich the intent map to generate an enriched intent map. Metadata stored in the metadata repository (e.g., 150) may include information about available tables, columns, data types, time dimensions, relationships, predefined business rules, etc. By referencing such metadata, the AI model can infer missing information, validate extracted fields, and enhance the completeness and accuracy of the intent map.

An example of a metadata structure stored in the metadata repository is shown in Listing 3 below:

Listing 3: Example metadata structure.

```
{
  “table”: “SalesData”,
  “columns”: {
    “Revenue”: “Currency”,
    “Cost”: “Currency”,
    “SalesVolume”: “Integer”,
    “Product”: “String”,
    “Category”: “String”,
    “BrandType”: “String”,
    “Region”: “String”,
    “Year”: “Integer”
  },
  “time_dimension”: “Year”
}
```

Using this metadata, the AI model can perform several types of enrichment. For example, the initial intent map shown in Listing 1 identifies “profitability” and “sales_growth” as requested measures and “profit_margin percentage” as a calculated column (see Listing 1 above). The AI model can consult the metadata and associated business rules to infer the appropriate formulas for these metrics. Specifically:
“Profitability” can be inferred as the difference between “Revenue” and “Cost.”
“Sales Growth” can be inferred as the percentage increase in Revenue between the current year and the previous year.
“Profit Margin Percentage” can be inferred as the ratio of profit to revenue, expressed as a percentage.

Based on these inferences, the AI model can generate an enriched intent map as shown in Listing 4 follows:

The AI model can then generate enriched definitions for these specific measures and calculated columns based on metadata lookup and rule inference. Listing 4 below shows an example of the enriched portion of the intent map related to the inferred measures and calculated fields. Other parts of the original intent map from Listing 1, such as filters, dimensions, products, and categories, can remain and be carried forward into subsequent processing steps.

Listing 4: Example enriched definitions for measures and calculated columns.

```
[
  {
    “measure”: “profitability”,
    “formula”: “(Revenue − Cost)”
  },
  {
    “measure”: “sales_growth”,
    “formula”: “((SUM(Revenue WHERE Year = CURRENT_YEAR) − SUM(Revenue
WHERE Year = CURRENT_YEAR − 1)) / SUM(Revenue WHERE Year =
CURRENT_YEAR − 1)) * 100”,
    “type”: “percentage”
  },
  {
    “calculated_column”: “profit_margin_percentage”,
    “formula”: “((Revenue − Cost) / Revenue) * 100”,
    “type”: “percentage”
  }
]
```

The enriched intent map thus expands upon the initial extracted fields by attaching explicit formulas and types where needed. Each inferred formula references fields (e.g., “Revenue,” “Cost,” “Year”) that have been validated against the metadata. Time-aware logic, such as identifying “current year” and “prior year” values for sales growth calculation, can also be inferred by recognizing that “Year” is a time dimension in the metadata.

### Example Intent-Action Mapping

After enriching the initial intent map through metadata integration, the AI model proceeds to map the user intent into a structured action list. This mapping process can be coordinated by the auto query generator (e.g., 130), which references a predefined action library (e.g., 140). The action library contains structured mappings that associate types of user intents and extracted fields with corresponding query-building actions that are compatible with the proprietary analytics platform. An example structure of the action library is shown below:

Listing 5: Example structure of the action library.

```
{
  “action_library”: {
    “version”: “1.0”,
    “tool”: “AnalyticsToolX”,
    “actions”: [
      {
        “action_id”: “add_filter”,
        “description”: “Adds a filter to restrict data based on a field and value(s)”,
        “ui_trigger”: “User drags a field to the filter pane or specifies a condition in natural
language”,
        “parameters”: {
          “field”: {
            “type”: “string”,
            “description”: “The data field to filter on (e.g., ‘BrandType’, ‘Region’)”
          },
          “values”: {
            “type”: “array|string”,
            “description”: “The value(s) to filter by (e.g., ‘premium’, [‘sneakers', ‘boots'])”
          },
          “operator”: {
            “type”: “string”,
            “default”: “equals”,
            “options”: [
              “equals”,
              “not_equals”,
              “greater_than”,
              “less_than”,
              “in”
            ],
            “description”: “The comparison operator”
          }
        },
        “query_mapping”: {
          “target_format”: “json”,
          “structure”: {
            “dataFilters”: {
              “field”: “{field}”,
              “values”: “{values}”,
              “operator”: “{operator}”
            }
          }
        },
        “example”: {
          “input”: {
            “field”: “BrandType”,
            “values”: “premium”,
            “operator”: “equals”
          },
          “output”: {
            “dataFilters”: {
              “field”: “BrandType”,
              “values”: “premium”,
              “operator”: “equals”
            }
          }
        }
      },
      {
        “action_id”: “add_measure”,
        “description”: “Adds a metric or measure to the query for aggregation”,
        “ui_trigger”: “User selects a metric from a dropdown or specifies a calculation in
natural language”,
        “parameters”: {
          “name”: {
            “type”: “string”,
            “description”: “Name of the measure (e.g., ‘profitability’)”
          },
          “formula”: {
            “type”: “string”,
            “description”: “The formula or aggregation logic (e.g., ‘(Revenue − Cost)’)”
          },
          “render_type”: {
            “type”: “string”,
            “default”: “numeric”,
            “options”: [
              “numeric”,
              “currency”,
              “percent”
            ],
            “description”: “How the measure should be displayed”
          }
        },
        “query_mapping”: {
          “target_format”: “json”,
          “structure”: {
            “metricPayload”: {
              “name”: “{name}”,
              “formula”: “{formula}”,
              “renderType”: “{render_type}”
            }
          }
        },
        “example”: {
          “input”: {
            “name”: “profitability”,
            “formula”: “(Revenue − Cost)”,
            “render_type”: “currency”
          },
          “output”: {
            “metricPayload”: {
              “name”: “profitability”,
              “formula”: “(Revenue − Cost)”,
              “renderType”: “currency”
            }
          }
        }
      }
    ]
  }
}
```

The auto query generator uses this action library to determine how each component of the enriched intent map should be translated into a platform-specific action. For example, fields such as “BrandType” or “Region” specified in filters can be mapped to add_filter actions, and metrics such as “profitability” and “sales_growth” can be mapped to add_measure actions with their associated formulas. Using the enriched intent map, the auto query generator can produce the following structured action list:

Listing 6: Example action list.

```
{
  “actions”: [
    {
      “action”: “add_filter”,
      “field”: “Product”,
      “values”: [“sneakers”, “boots”, “jackets”],
      “operator”: “in”
    },
    {
      “action”: “add_filter”,
      “field”: “Category”,
      “values”: [“Footwear”, “Outerwear”],
      “operator”: “in”
    },
    {
      “action”: “add_filter”,
      “field”: “BrandType”,
      “values”: “premium”,
      “operator”: “equals”
    },
    {
      “action”: “add_filter”,
      “field”: “Region”,
      “values”: “North America”,
      “operator”: “equals”
    },
    {
      “action”: “add_dimension”,
      “field”: “Category”,
      “sequence”: 1
    },
    {
      “action”: “add_dimension”,
      “field”: “Year”,
      “sequence”: 2
    },
    {
      “action”: “add_measure”,
      “name”: “profitability”,
      “formula”: “(Revenue − Cost)”,
      “render_type”: “currency”
    },
    {
      “action”: “add_measure”,
      “name”: “sales_growth”,
      “formula”: “((SUM(Revenue WHERE Year = CURRENT_YEAR) − SUM(Revenue
WHERE Year = CURRENT_YEAR − 1)) / SUM(Revenue WHERE Year =
CURRENT_YEAR − 1)) * 100”,
      “render_type”: “percent”
    },
    {
      “action”: “add_calculated_column”,
      “name”: “profit_margin_percentage”,
      “formula”: “((Revenue − Cost) / Revenue) * 100”,
      “render_type”: “percent”
    }
  ]
}
```

Each action in the action list provides a structured, tool-specific representation of operations that the analytics platform can perform to construct and execute the analytical query. The action list serves as the intermediate blueprint, ensuring that all user intents, such as field selections, filters, calculated fields, and aggregations, are properly translated into precise, platform-compliant query operations.

### Example Contextual Enhancement

In some examples, after generating an initial action list based on the enriched intent map, the AI model can further refine the action list using contextual information retrieved from user history. Such contextual enhancement can improve the relevance, completeness, and personalization of the generated analytical queries based on prior user behavior.

In some implementations, the context analyzer (e.g., 134) can be configured to retrieve a user history associated with the current user request from the query history module (e.g., 114). In some examples, the user history may include historical analytical queries from previous user sessions, reflecting long-term user preferences, commonly used filters, and typical analytical patterns. In some examples, the user history may include query actions or intermediate queries created earlier within the same user session, capturing the ongoing context of the user's current analytical workflow. In some examples, the user history may record various elements, such as applied filters, selected fields, calculated columns, grouping dimensions, etc.

Upon retrieving the user history, the context analyzer can analyze historical patterns to identify potential query refinements related to the user's current intent. If a relevant refinement is identified, the auto query generator can refine the action list accordingly. Refinement may include adding one or more new actions to the action list and/or modifying one or more existing actions in the action list to better align with the user's historical patterns or preferences.

As an example, consider a scenario where the user history includes a previously applied filter specifying “Year=2025.” If the current user request does not contradict this historical filter (for example, the current request does not specify a different year or impose an inconsistent time frame), the AI model can automatically incorporate this refinement into the current action list. Specifically, the system can add a new filter action, as shown in Listing 7 below, to the action list previously generated and shown in Listing 6:

Listing 7: Example new filter action added based on user history.

```
{
  “action”: “add_filter”,
  “field”: “Year”,
  “value”: “2025”,
  “operator”: “equals”
}
```

This contextual enhancement allows the AI model to proactively add meaningful constraints to the analytical query, ensuring consistency with the user's historical analysis patterns without requiring explicit re-specification by the user. In some examples, if the current user request already specifies a conflicting filter (e.g., “Year=2024”), the AI model can intelligently avoid adding the historical refinement to prevent contradictions.

### Example Query Assembly

After generating the action list (which, optionally, can be contextually enhanced), the AI model can proceed to assemble the final analytical query (e.g., using the query constructor 138). The query assembly process systematically translates the action list into a structured analytical query that is compatible with the proprietary analytics platform. Each step of the assembly process can incorporate schema mapping and business metadata validation (e.g., performed by the schema validator 136) to ensure that the generated analytical query is syntactically and semantically correct.

First, the AI model selects output fields based on the user intent, such as measures, calculated columns, grouping dimensions, etc. Validation is performed to ensure that each selected field exists in the business metadata, that the data types match expected formats, and that the field names are consistent with the schema. An example of the selected output fields is shown in Listing 8, where the selected measures include “profitability” and “sales_growth,” the calculated column is “profit_margin_percentage,” and the grouping dimensions are “Category” and “Year.”

Listing 8: Example selected output fields.

```
{
  “measures”: [“profitability”, “sales_growth”],
  “calculated_columns”: [
    {
      “name”: “profit_margin_percentage”,
      “type”: “percentage”
    }
  ],
  “dimensions”: [“Category”, “Year”]
}
```

Next, the AI model can apply filters extracted from the enriched intent map and action list to constrain the dataset appropriately. Each filter is validated to ensure that the corresponding field exists in the schema and that the filter value matches the expected data type. Listing 9 illustrates an example of the applied filters, where filters are defined for “Product,” “Category,” “BrandType,” and “Region.” In this example, the applied filters are organized under a “dataFilters” field, which specifies the fields to be filtered, the values to match, and the comparison operators to be used.

Listing 9: Example applied filters.

```
{
  “dataFilters”: [
    {
      “field”: “Product”,
      “values”: [“sneakers”, “boots”, “jackets”]
    },
    {
      “field”: “Category”,
      “values”: [“Footwear”, “Outerwear”]
    },
    {
      “field”: “BrandType”,
      “value”: “premium”
    },
    {
      “field”: “Region”,
      “value”: “North America”
    }
  ]
}
```

The AI model can then define the grouping and aggregation plan for the query. The grouping plan specifies the order of dimensions to be used in result organization and aggregation. Similarly, metadata validation can be performed to ensure that the grouping fields exist and that the specified aggregation mode is supported. Listing 10 shows an example grouping plan where results are grouped first by “Category” and then by “Year,” using a “nestedBreakdown” aggregation mode. In this example, the grouping instructions are organized under a “groupingPlan” field, which is a platform-specific structure defined by the proprietary analytics platform for specifying the grouping hierarchy and aggregation behavior of the query results.

Listing 10: Example grouping plan.

```
{
  “groupingPlan”: {
    “dimensions”: [
      {
        “field”: “Category”,
        “sequence”: 1
      },
      {
        “field”: “Year”,
        “sequence”: 2
      }
    ],
    “aggregationMode”: “nestedBreakdown”
  }
}
```

Further, the AI model can construct a metric payload that defines how each measure should be calculated and displayed in the output. Each measure can be represented along with its associated formula and render type, such as currency or percentage. Validation is performed to ensure that all fields referenced in the formulas exist in the metadata and that the rendering types are supported by the platform. Listing 11 presents an example metric payload, where the “profitability” metric is defined by the formula “(Revenue-Cost)” and the “sales_growth” is calculated as a year-over-year percentage growth in revenue. In this example, the metric definitions are organized under a “metricPayload” field, which is a platform-specific structure used to define the computational logic for those measures.

Listing 11: Example metric payload.

```
{
  “metricPayload”: [
    {
      “name”: “profitability”,
      “formula”: “(Revenue − Cost)”,
      “renderType”: “currency”
    },
    {
      “name”: “sales_growth”,
      “formula”: “((SUM(Revenue WHERE Year =
CURRENT_YEAR) − SUM(Revenue WHERE Year =
CURRENT_YEAR − 1)) / SUM(Revenue WHERE Year =
CURRENT_YEAR − 1)) * 100”,
      “renderType”: “percent”
    }
  ]
}
```

In addition to standard measures, the AI model can add computed extras such as user-defined calculated fields. Each calculated field includes a name and an associated calculation expression that defines how the field is derived from existing data. Each calculated field is validated to ensure that its expression is syntactically correct, that it references existing fields from the metadata, and that the assigned units and data types are consistent with schema definitions. Listing 12 shows an example of a calculated field named “profitMarginPercent,” which uses the expression “((Revenue−Cost)/Revenue)*100” to calculate the profit margin as a percentage. In this example, the calculated fields are organized under a “calculatedFields” field, which is also a platform-specific structure designed to capture additional user-requested computations.

Listing 12: Example calculated fields.

```
{
  “calculatedFields”: {
    “items”: [
      {
        “name”: “profitMarginPercent”,
        “expression”: “((Revenue − Cost) / Revenue) * 100”,
        “unit”: “percent”
      }
    ]
  }
}
```

After assembling all query components, the AI model can format the final analytical query into a structured query blueprint that the analytics platform can execute. The complete query blueprint organizes filters, grouping plans, metrics, and calculated fields into a single structured object. Listing 13 shows an example of the final query blueprint formatted in JSON, capturing all major query components, including the filters shown in Listing 9, the grouping plan shown in Listing 10, the metric payload shown in Listing 11, and the calculated fields shown in Listing 12. In this example, this query blueprint is structured under a “queryBlueprint” field, which is a platform-specific container that defines the overall query specification.

Listing 2: Example final query blueprint (JSON format).

```
{
  “queryBlueprint”: {
    “specVersion”: “4.2”,
    “queryType”: “analyticalInsight”,
    “dataFilters”: [...],
    “groupingPlan”: {...},
    “metricPayload”: [...],
    “calculatedFields”: {...}
  }
}
```

While the example query components and query blueprint shown above (e.g., Listings 8-13) are illustrated using JSON formatting, the final analytical query can also be serialized into other formats depending on the requirements of the proprietary analytics platform. For example, the same logical query structure can be expressed in XML, preserving the organizational layout of filters, grouping plans, metric payloads, and calculated fields, as illustrated in Listing 14 below.

Listing 14: Example final query blueprint (XML format).

```
<queryBlueprint specVersion=“4.2” queryType=“analyticalInsight”>
  <dataFilters> ... </dataFilters>
  <groupingPlan> ... </groupingPlan>
  <metricPayload> ... </metricPayload>
  <calculatedFields> ... </calculatedFields>
</queryBlueprint>
```

Following the assembly of the complete query blueprint, a final schema-based validation can be performed to ensure that all components of the query blueprint comply with the business metadata, schema definitions, and query formatting rules of the proprietary analytics platform. This validation step ensures that the AI-generated analytical query can be executed reliably and accurately.

### Example Integration of Preliminary Queries

In some cases, refining the dataset before applying the main analytical query logic may improve the precision or relevance of the query results. To support such scenarios, the AI model can generate preliminary queries, also referred to as subqueries, as part of the overall structured query blueprint. A subquery operates as a preparatory step, producing an intermediate result set that is then referenced by the main query logic.

In general, a subquery is needed when filtering, grouping, or calculation at an initial level can materially change the dataset before the main query operations are performed. For example, a subquery may be needed to first retrieve the top N products by sales before analyzing profitability across selected categories, to group and rank regions by total revenue before applying subsequent measures, to pre-filter customers based on dynamic thresholds such as the highest average order value, etc. In such cases, the subquery refines the dataset in a way that may directly impact the measures, filters, or dimensions applied in the main query logic.

In some examples, the need for a subquery can be identified based on an analysis of the user intent, the impact on the base dataset, and optionally the complexity of requested filters or aggregations. For example, if the user intent specifies a requirement to operate on a dynamically determined subset of data, such as “top 10 products by sales”, the AI model can determine that a subquery is needed because selecting the top 10 products must occur before further calculations or grouping can be applied. Listing 15 shows an example where a subquery is introduced to retrieve the top 10 products based on sales volume.

Listing 15: Example identifying the need for a subquery.

```
{
  “intent”: “analysis”,
  “subquery”: {
    “description”: “Filter top 10 products by sales”,
    “query”: {
      “select”: [“Product”, “Sales”],
      “from”: “SalesData”,
      “orderBy”: [
        {
          “field”: “Sales”,
          “direction”: “desc”
        }
      ],
      “limit”: 10
    }
  },
  “mainQuery”: {
    “measures”: [“profitability”],
    “dimensions”: [“Category”, “Year”],
    “filters”: [
      {
        “field”: “Product”,
        “values”: “subquery”
      }
    ]
  }
}
```

When a subquery is needed, it can be defined as a separate block within the JSON structure, containing its own select, from, groupBy, orderBy, and limit clauses. Thus, the subquery can independently prepare a refined dataset that satisfies the initial filtering or aggregation needs. Listing 16 shows another example subquery where the AI model retrieves the top-performing regions based on aggregated revenue.

Listing 16: Example subquery structure.

```
{
  “subquery”: {
    “description”: “Retrieve top-performing regions”,
    “query”: {
      “select”: [“Region”, “SUM(Revenue) as TotalRevenue”],
      “from”: “SalesData”,
      “groupBy”: [“Region”],
      “orderBy”: [
        {
          “field”: “TotalRevenue”,
          “direction”: “desc”
        }
      ],
      “limit”: 5
    }
  }
}
```

Once the subquery is defined, the AI model can link the subquery output to the main analytical query. In some implementations, the results of the subquery can be referenced as dynamic filter values or input datasets in the main query logic. Listing 17 shows an example where the results of a subquery are referenced in the filters section of the main query to restrict the analysis to regions identified by the subquery.

Listing 17: Example linking subquery results to the main query.

```
{
  “mainQuery”: {
    “measures”: [“profitability”],
    “dimensions”: [“Category”, “Year”],
    “filters”: [
      {
        “field”: “Region”,
        “values”: “subquery”
      }
    ]
  }
}
```

Finally, the AI model can format the complete analytical query into a final JSON (or XML) query blueprint that seamlessly integrates both the subquery and the main query components. The resulting structure allows the analytics platform to first execute the subquery to produce a refined result set, and then apply the main query logic to that result. Listing 18 shows an example of the final query blueprint with integrated subquery and main query.

Listing 18: Example final query blueprint
integrating subquery and main query.

```
{
  “queryBlueprint”: {
    “specVersion”: “4.2”,
    “queryType”: “analyticalInsight”,
    “subquery”: {
      “description”: “Retrieve top-performing regions”,
      “query”: {
        “select”: [“Region”, “SUM(Revenue) as TotalRevenue”],
        “from”: “SalesData”,
        “groupBy”: [“Region”],
        “orderBy”: [
          {
            “field”: “TotalRevenue”,
            “direction”: “desc”
          }
        ],
        “limit”: 5
      }
    },
    “mainQuery”: {
      “measures”: [“profitability”],
      “dimensions”: [“Category”, “Year”],
      “filters”: [
        {
          “field”: “Region”,
          “values”: “subquery”
        }
      ]
    }
  }
}
```

Through this preliminary query integration approach, the AI model enables dynamic, multi-stage analytical queries to be automatically generated and executed at runtime. By identifying when a subquery is needed based on user intent and data preparation needs, even complex analytical workflows can be automatically and seamlessly handled without requiring manual intervention.

### Example Query Adjustment

In some scenarios, after an initial analytical query is generated, the user may wish to modify or extend the query by adding a new field or filter. To accommodate such dynamic adjustments, the AI model can be configured to seamlessly update the query structure in runtime, ensuring that all modifications are properly validated, mapped, and integrated without disrupting the original query logic. The query adjustment process can include the following steps:

First, the natural language input from the user is parsed (e.g., by the NLP engine 132) to understand the modification request and extract a new intent. For example, if the user inputs “Add a filter for products in the Accessories' category,” the AI model can parse and recognize the addition of a new filter related to the “Category” field.

Next, the AI model can update the intent map to incorporate the newly parsed information. The intent map can be modified to include the new filter field, value, and operator as appropriate. Listing 19 shows an example of the newly added filter to the intent map. It should be understood that Listing 19 illustrates only the incremental update, and that other previously extracted components of the intent map (such as prior measures, dimensions, and filters) remain and are carried forward.

Listing 19: Example added filters to the intent map.

```
{
  “filters”: [
    {
      “field”: “Category”,
      “values”: [“Accessories”],
      “operator”: “in”
    }
  ]
}
```

After successful validation, the AI model can map the new user intent to the corresponding action by referencing the action library. The mapping process identifies the appropriate tool-specific query operation that must be performed for the newly added filter. Listing 20 shows an example of the new action derived from the mapping. In this example, only the new action is listed, while actions already present in the action list are omitted.

Listing 20: Example new action derived
from action library mapping.

```
{
  “action”: “add_filter”,
  “field”: “Category”,
  “values”: [“Accessories”],
  “operator”: “in”
}
```

The AI model then update the existing query structure by integrating the newly mapped action. The updated query structure can add the new filter to the existing “dataFilters” block without altering unrelated parts of the query. Listing 21 shows an example of the added filter. For simplicity, this example shows only the incremental update and omits the full updated query structure.

Listing 21: Example updated query snippet with new filter.

```
{
  “dataFilters”: [
    {
      “field”: “Category”,
      “values”: [“Accessories”],
      “operator”: “in”
    }
  ]
}
```

Following the query update, schema validation can be performed to ensure that the updated query continues to conform to the business metadata, tool-specific syntax, and semantic rules.

Finally, the AI model can generate the final analytical query incorporating the added field or filter, ready for execution by the query execution engine. Throughout this adjustment process, the system efficiently reuses the existing query structure, integrating modifications incrementally without reconstructing the entire query from scratch. This reuse not only preserves structural and semantic accuracy, but also optimizes performance by minimizing redundant query generation steps. As a result, users are able to interactively refine and extend analytical queries in runtime, enabling dynamic and efficient query evolution.

### Example Overall Process for Automatic Generation of Analytical Queries

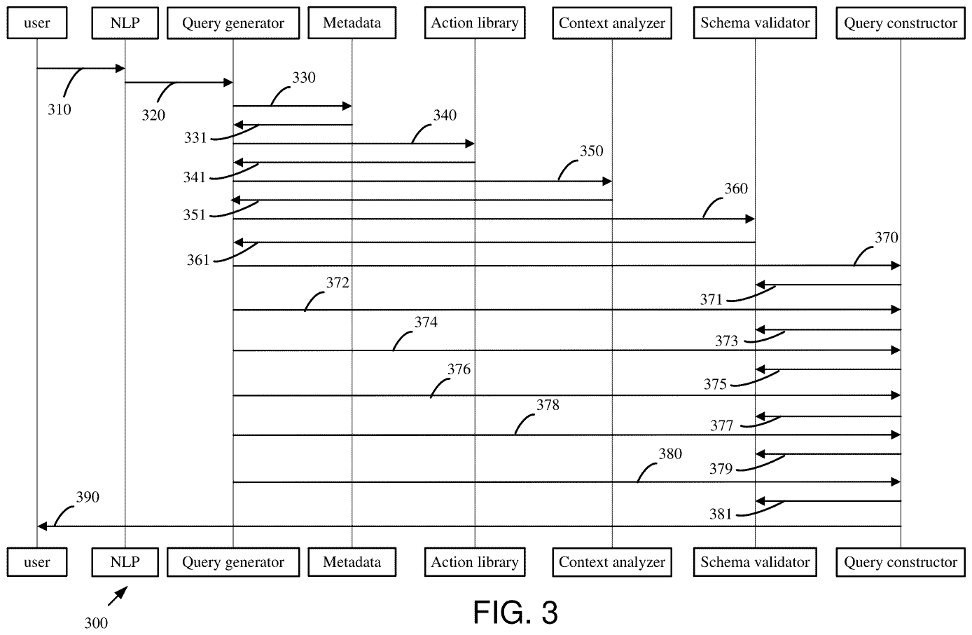

FIG. 3 is a sequence diagram depicting an example process 300 for automatically generating an analytical query responsive to a user request. The process 300 can be performed by the computing system 100 described above with respect to FIG. 1. As shown, the process 300 involves interactions between a user (e.g., 102) and multiple system components, including an NLP engine (e.g., 132), an auto query generator (e.g., 130), a metadata repository (e.g., 150), an action library (e.g., 140), a context analyzer (e.g., 134), a schema validator (e.g., 136), and a query constructor (e.g., 138).

At step 310, the user provides a user request through the user interface in natural language, expressing an intent to perform an analytical operation ((e.g., “Analyze profitability for premium brand sneakers in North America”). The natural language request is received by the NLP engine.

At step 320, the NLP engine parses the natural language input into a structured intent map and provides the structured intent map to the auto query generator. The structured intent map identifies user intents, measures, dimensions, filters, and other relevant fields, as described above.

At step 330, the auto query generator sends the initial intent map to the metadata repository for enrichment. The metadata repository uses stored metadata to infer formulas, validate field mappings, and enrich type information. At step 331, the metadata repository returns an enriched intent map to the auto query generator, now augmented with inferred formulas and metadata-enriched structures.

At step 340, the auto query generator sends the user intents to the action library to perform platform-specific action mapping. The action library applies predefined mapping rules to associate user intents with appropriate query-building actions. At step 341, the action library returns an action list to the auto query generator, containing structured actions ready for subsequent query assembly.

At step 350, the auto query generator sends a request to the context analyzer to retrieve user history and identify possible refinements based on prior interactions. The context analyzer analyzes the historical data to detect potential query refinements, such as commonly applied filters or preferred measures. At step 351, the context analyzer returns a context-enhanced action list to the auto query generator.

At step 360, the auto query generator initiates a preliminary validation of the evolving query structure by sending the assembled components to the schema validator. The schema validator checks structural compliance against metadata and platform requirements. At step 361, the schema validator returns a confirmation of structural accuracy (or identifies any issues to be addressed).

At step 370, the auto query generator proceeds with selecting output fields based on the user intent and action list. The selected output fields can include measures, dimensions, and any calculated columns identified earlier. The selected fields are provided to the query constructor, which is responsible for assembling these fields into the evolving query structure. At step 371, the query constructor calls the schema validator to validate that the selected fields exist in the metadata, have compatible data types, and are properly associated with aggregation rules.

At step 372, the auto query generator applies inferred filters based on the filter-related actions identified in the action list. The corresponding filters are provided to the query constructor, which integrates the filters into the evolving query structure. At step 373, the query constructor calls the schema validator to validate each applied filter, ensuring that the filter fields exist in the metadata, that the filter values match expected data types, and that the specified operators are appropriate based on schema constraints.

At step 374, the auto query generator defines a grouping or aggregation plan for the query based on the grouping-related actions mapped previously. The grouping plan, including dimension ordering and aggregation modes, is provided to the query constructor for incorporation into the evolving query structure. At step 375, the query constructor calls the schema validator to validate that the specified grouping dimensions exist in the metadata and that the aggregation modes are compatible with the platform requirements.

At step 376, the auto query generator constructs a metric payload by assembling the measures and associated formulas derived from the enriched intent map. The metric payload is provided to the query constructor, which integrates the measures into the query structure. At step 377, the query constructor calls the schema validator to validate the metric payload, ensuring that all fields referenced in the formulas exist in the metadata and that the formulas conform to syntax and business rules of the proprietary analytics platform.

At step 378, the auto query generator adds computed extras to the query, such as user-requested calculated fields, derived expressions, and/or custom metrics. These computed fields are provided to the query constructor, which adds them into the appropriate sections of the evolving query structure. At step 379, the query constructor calls the schema validator to validate the syntax, field references, and unit consistency of the calculated fields against the metadata.

At step 380, after all validated query components are assembled, the auto query generator instruct the query constructor to format the complete query structure into a final query blueprint. The query constructor then organizes the filters, groupings, measures, and calculated fields into a platform-specific query specification, which may be serialized in JSON, XML, or another supported format. At step 381, the query constructor calls the schema validator to perform a final validation pass, ensuring that the complete query structure complies with metadata definitions, schema mappings, and platform-specific syntax requirements.

At step 390, after successful final validation, the completed analytical query is returned to the user. The generated analytical query is then ready for execution by the query execution engine of the proprietary analytics platform to generate output responsive to the original user request.

### Example Process for Incorporating Preliminary Queries

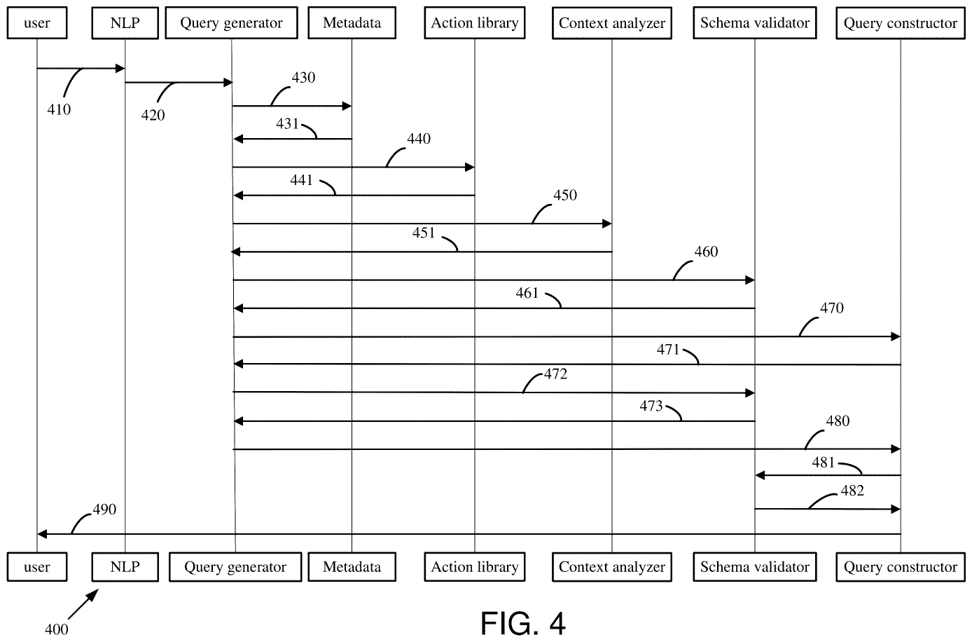

FIG. 4 is a sequence diagram depicting an example process 400 for incorporating a preliminary query in automatic generation of an analytical query. The process 400 can be performed, for example, by the computing system 100 of FIG. 1. As shown, the process 400 extends the automatic query generation flow to dynamically handle scenarios where a preliminary query (i.e., a subquery) is needed to refine the dataset prior to applying the main query logic.

At step 410, the user provides a natural language request through the user interface, which may implicitly or explicitly require a subquery (e.g., “Analyze profitability for the top 10 selling products in 2025”). The natural language request is first processed by the NLP engine.

At step 420, the NLP engine parses the natural language input into a structured intent map and provides the structured intent map to the auto query generator. The structured intent map captures key elements such as user intents, requested measures, dimensions, filters, and any detected conditions that could trigger subquery generation.

At step 430, the auto query generator sends the initial intent map to the metadata repository for enrichment. The metadata repository uses stored metadata to infer formulas, validate field mappings, and enrich type information. At step 431, the metadata repository returns an enriched intent map to the auto query generator.

At step 440, the auto query generator sends the parsed user intents to the action library for mapping to platform-specific actions. The action library applies predefined mapping rules to associate user intents with appropriate query-building actions. At step 441, the action library returns the generated action list containing structured actions ready for query construction.

At step 450, the auto query generator requests the context analyzer to retrieve user history and identify possible refinements based on prior interactions. The context analyzer analyzes historical data to detect potential query refinements. At step 451, the context analyzer returns a context-enhanced action list to the auto query generator.

At step 460, the auto query generator sends the evolving query structure to the schema validator for preliminary validation. The schema validator checks structural compliance with metadata and platform-specific requirements. At step 461, the schema validator returns confirmation of structural accuracy or identifies any issues for correction.

At step 470, based on the enriched intent map and the action list, the auto query generator identifies the need for a preliminary query (i.e., a subquery). For example, if the intent requires operating on a ranked subset of data, such as selecting the top N products, a subquery is needed to refine the dataset. The auto query generator instructs the query constructor to initiate the creation of a separate subquery structure to handle the refinement.

At step 471, the query constructor defines the subquery structure which specifies select fields, grouping logic, ordering criteria, and limit conditions necessary to prepare the refined result set, and returns the completed subquery structure to the auto query generator.

At step 472, the auto query generator sends the subquery structure to the schema validator for validation. The schema validator checks that the subquery's fields, aggregations, and expressions conform to metadata rules and syntax requirements. At step 473, the schema validator returns confirmation that the subquery structure is valid, or provides error feedback if adjustments are needed.

At step 480, following successful subquery validation, the auto query generator instructs the query constructor to integrate the subquery into the main query structure. The query constructor updates the evolving query by incorporating a reference to the subquery, either as a dynamic filter input or as an alternate data source, depending on the analytical objective.

At step 481, after the integration is completed, the query constructor sends the updated main query structure, including the integrated subquery, to the schema validator for validation. The schema validator verifies that the full query structure, including subquery integration, complies with metadata constraints and platform-specific syntax requirements. At step 482, the schema validator returns confirmation that the complete analytical query, with the integrated subquery, is valid and ready for execution.

Finally, at step 490, after successful final validation, the query constructor finalizes the assembly of the fully constructed analytical query, including the integrated subquery. The auto query generator then returns the finalized and validated analytical query to the user. The analytical query is ready for execution by the analytics platform's query execution engine to generate output responsive to the user's original request.

### Example Process for Modifying Generated Analytical Queries

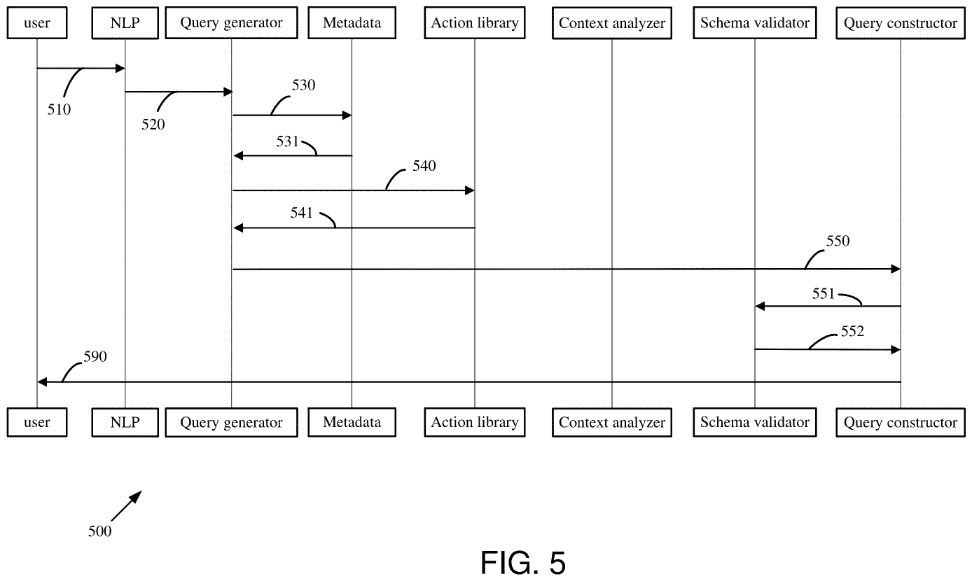

FIG. 5 is a sequence diagram depicting an example process 500 for modifying an automatically generated analytical query. The process 500 can be performed, for example, by the computing system 100 of FIG. 1. As described above, the process 500 extends the capabilities of automatic query generation to support interactive modifications, such as adding new filters, fields, and/or calculated columns based on subsequent user requests.

At step 510, the user submits a modification request through the user interface. The modification may involve actions such as adding a new filter, selecting an additional field, and/or applying a new calculation to the existing analytical query. The request is received by the NLP engine for processing.

At step 520, the NLP engine parses the user's modification request and updates the existing intent map to reflect the newly requested changes. The updated intent map now incorporates additional user intents or fields that were not present in the original query.

At step 530, the auto query generator sends the updated fields, filters, or calculations to the metadata repository for validation. The metadata repository verifies whether the new fields or filters exist in the schema and whether their associated values or types are compatible with the database schema and platform rules. At step 531, the metadata repository returns confirmation that the newly requested fields or filters are valid and can be incorporated into the analytical query structure. If any issues are detected, error feedback can be provided instead.

At step 540, the auto query generator maps the intended modifications to platform-specific query actions by referencing the predefined rules stored in the action library (e.g., a request to add a new filter would be mapped to an “add_filter” action). At step 541, the action library returns an updated action list reflecting both the original query operations and the newly requested actions.

At step 550, the auto query generator instructs the query constructor to integrate the newly mapped actions into the evolving query structure. The query constructor updates the existing analytical query by inserting or modifying fields, filters, and/or calculations according to the user's requested changes.

At step 551, the query constructor sends the updated query structure to the schema validator for validation to ensure that the modified query structure maintains compliance with metadata definitions, schema constraints, and platform-specific syntax requirements. At step 552, the schema validator returns confirmation that the updated analytical query structure is valid and ready for execution. If any structural or semantic issues are identified, corrective feedback may be generated.

Finally, at step 590, the updated and validated analytical query is returned to the user. The updated analytical query is then ready for execution by the analytics platform's query execution engine, allowing the user to see results responsive to the newly applied changes without rebuilding the entire query from scratch.

### Example Advantages

As described above, conventional approaches to analytical query generation often require users to manually construct queries using specialized user interfaces. Even in platforms that offer simplified visual query builders, users are typically burdened with the need to understand underlying database schemas, ensure compatibility with metadata constraints, and manually validate the correctness of constructed queries. This manual process is time-consuming, error-prone, and can introduce inconsistencies, particularly when queries become more complex or when dynamic updates are required.

The technologies described herein address these challenges by introducing an automated, AI-powered system for generating and modifying analytical queries based on natural language user input. By leveraging a trained AI model, the system can intelligently interpret user intents, enrich query structures with context-aware metadata, and dynamically adapt query operations to meet platform-specific requirements. This enables the system to generate accurate, executable analytical queries with minimal manual intervention. The use of the trained AI model allows for efficient handling of evolving user requests, improved consistency in query construction, and reduced risk of syntax or semantic errors compared to conventional manual approaches.

Technical advantages of the disclosed system and methods include the ability to integrate metadata at runtime for intelligent formula inference, perform modular query construction based on dynamically mapped actions, and validate evolving query structures against schema and platform-specific rules during the generation process. The technologies disclosed herein can also seamlessly incorporate preliminary queries (subqueries) when dataset refinement is needed, without interrupting the query assembly workflow. By supporting dynamic updates and validations at runtime, the disclosed solution enhances robustness, adaptability, and accuracy of generated queries while minimizing manual intervention. This runtime-driven approach enables users to adjust queries interactively based on evolving analytical needs, improving both responsiveness and computational efficiency compared to conventional static approaches.

### Example Computing Systems

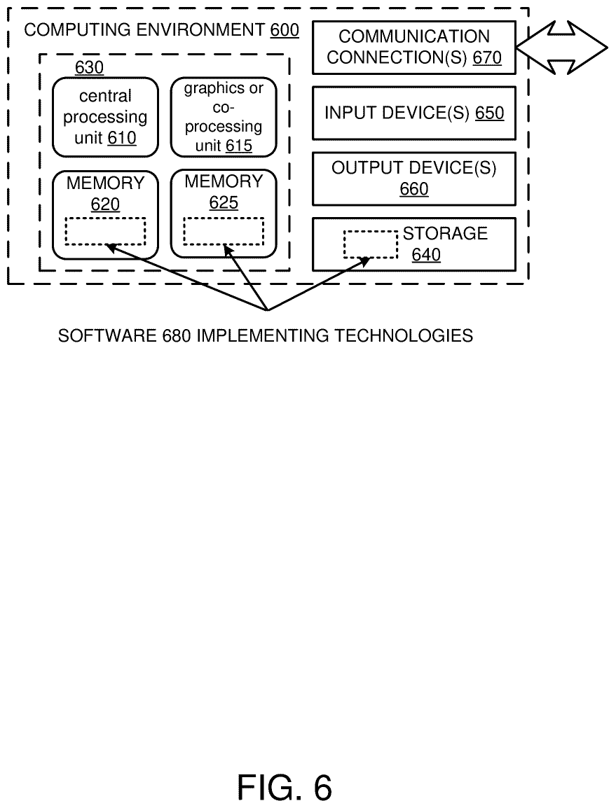

FIG. 6 depicts an example of a suitable computing system 600 in which the described innovations can be implemented. The computing system 600 is not intended to suggest any limitation as to scope of use or functionality of the present disclosure, as the innovations can be implemented in diverse computing systems.

With reference to FIG. 6, the computing system 600 includes one or more processing units 610, 615 and memory 620, 625. In FIG. 6, this basic configuration 630 is included within a dashed line. The processing units 610, 615 can execute computer-executable instructions, such as for implementing the features described in the examples herein (e.g., the method 200). A processing unit can be a general-purpose central processing unit (CPU), processor in an application-specific integrated circuit (ASIC), or any other type of processor. In a multi-processing system, multiple processing units can execute computer-executable instructions to increase processing power. For example, FIG. 6 shows a central processing unit 610 as well as a graphics processing unit or co-processing unit 615. The tangible memory 620, 625 can be volatile memory (e.g., registers, cache, RAM), non-volatile memory (e.g., ROM, EEPROM, flash memory, etc.), or some combination of the two, accessible by the processing unit(s) 610, 615. The memory 620, 625 can store software 680 implementing one or more innovations described herein, in the form of computer-executable instructions suitable for execution by the processing unit(s) 610, 615.

A computing system 600 can have additional features. For example, the computing system 600 can include storage 640, one or more input devices 650, one or more output devices 660, and one or more communication connections 670, including input devices, output devices, and communication connections for interacting with a user. An interconnection mechanism (not shown) such as a bus, controller, or network can interconnect the components of the computing system 600. Typically, operating system software (not shown) can provide an operating environment for other software executing in the computing system 600, and coordinate activities of the components of the computing system 600.

The tangible storage 640 can be removable or non-removable, and includes magnetic disks, magnetic tapes or cassettes, CD-ROMs, DVDs, or any other medium which can be used to store information in a non-transitory way and which can be accessed within the computing system 600. The storage 640 can store instructions for the software implementing one or more innovations described herein.

The input device(s) 650 can be an input device such as a keyboard, mouse, pen, or trackball, a voice input device, a scanning device, touch device (e.g., touchpad, display, or the like) or another device that provides input to the computing system 600. The output device(s) 660 can be a display, printer, speaker, CD-writer, or another device that provides output from the computing system 600.

The communication connection(s) 670 can enable communication over a communication medium to another computing entity. The communication medium can convey information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components can include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing device to perform the method. The technologies described herein can be implemented in a variety of programming languages.

### Example Cloud Computing Environment

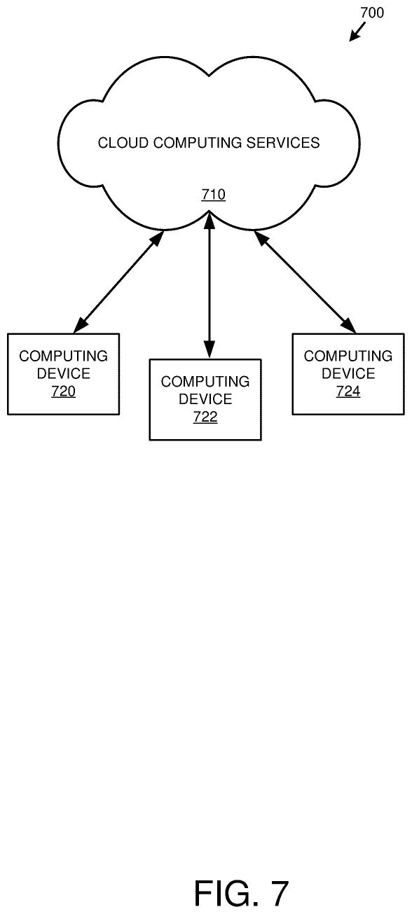

FIG. 7 depicts an example cloud computing environment 700 in which the described technologies can be implemented, including, e.g., the system 100 and other systems herein. The cloud computing environment 700 can include cloud computing services 710. The cloud computing services 710 can comprise various types of cloud computing resources, such as computer servers, data storage repositories, networking resources, etc. The cloud computing services 710 can be centrally located (e.g., provided by a data center of a business or organization) or distributed (e.g., provided by various computing resources located at different locations, such as different data centers and/or located in different cities or countries).

The cloud computing services 710 can be utilized by various types of computing devices (e.g., client computing devices), such as computing devices 720, 722, and 724. For example, the computing devices (e.g., 720, 722, and 724) can be computers (e.g., desktop or laptop computers), mobile devices (e.g., tablet computers or smart phones), or other types of computing devices. For example, the computing devices (e.g., 720, 722, and 724) can utilize the cloud computing services 710 to perform computing operations (e.g., data processing, data storage, and the like).

In practice, cloud-based, on-premises-based, or hybrid scenarios can be supported.

### Example Implementations

In any of the examples herein, a software application (or “application”) can take the form of a single application or a suite of a plurality of applications, whether offered as a service (SaaS), in the cloud, on premises, on a desktop, mobile device, wearable, or the like.

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

As described in this application and in the claims, the singular forms “a,” “an,” and “the” include the plural forms unless the context clearly dictates otherwise. Additionally, the term “includes” means “comprises.” Further, “and/or” means “and” or “or,” as well as “and” and “or.”

In any of the examples described herein, an operation performed in runtime or real-time means that the operation can be completed with negligible processing latency (e.g., the operation can be completed within 1 second, etc.).

### Example Clauses

Any of the following clauses can be implemented.

Clause 1. A computer-implemented method, comprising: receiving, from a user interface of a proprietary analytics platform, a user request in natural language for querying a database; and automatically generating an analytical query using a trained artificial intelligence model, comprising: generating, in runtime, an intent map based on natural language processing of the user request, wherein the intent map comprises a user intent and one or more measures extracted from the user request; enriching, in runtime, the intent map based on metadata of the database, wherein the enriching generates an enriched intent map comprising at least one inferred formula for calculating a measure extracted from the user request; mapping, in runtime, the user intent to an action list based on predefined rules stored in an action library, wherein the action list comprises one or more actions derived from the enriched intent map, wherein the one or more actions define query operations specific to the proprietary analytics platform; and constructing, in runtime, the analytical query based on the action list, wherein execution of the analytical query on the proprietary analytics platform generates an output responsive to the user request based on calculation of the measure using the at least one inferred formula.

Clause 2. The computer-implemented method of clause 1, wherein automatically generating the analytical query further comprises: retrieving, in runtime, a user history associated with the user request, wherein the user history comprises one or more historical queries previously generated based on prior user requests; identifying, in runtime, a query refinement related to the user intent from the user history; and refining, in runtime, the action list based on the query refinement, wherein refining the action list comprises adding a new action to the action list or modifying an existing action in the action list, wherein constructing the analytical query is based on the refined action list.

Clause 3. The computer-implemented method of any one of clauses 1-2, wherein constructing the analytical query comprises: selecting one or more output fields based on the user intent, wherein the one or more output fields comprise the one or more measures, and further comprise one or more dimensions or one or more calculated columns identified in the action list; and validating the one or more output fields against the metadata of the database to ensure that each output field corresponds to a valid field defined in the metadata.

Clause 4. The computer-implemented method of any one of clauses 1-3, wherein constructing the analytical query comprises: applying one or more filters identified in the action list to the analytical query, wherein each filter specifies a field and an associated filter value; and validating the one or more filters against the metadata of the database to ensure that each field specified in the one or more filters exists in the metadata and that each associated filter value conforms to a data type defined in the metadata.

Clause 5. The computer-implemented method of any one of clauses 1-4, wherein constructing the analytical query comprises: defining a grouping plan for the analytical query based on one or more dimensions identified in the action list, wherein the grouping plan specifies an order of the one or more dimensions and an aggregation mode; and validating the grouping plan against the metadata of the database to ensure that each dimension specified in the grouping plan exists in the metadata and that the aggregation mode is compatible with the metadata.

Clause 6. The computer-implemented method of any one of clauses 1-5, wherein constructing the analytical query comprises: constructing a metric payload comprising the one or more measures identified in the action list, wherein each measure is calculated by a corresponding formula; and validating the metric payload against the metadata of the database to ensure that each field referenced in each corresponding formula exists in the metadata and that each formula conforms to syntax rules defined by the proprietary analytics platform.

Clause 7. The computer-implemented method of any one of clauses 1-6, wherein constructing the analytical query comprises: adding one or more calculated fields to the analytical query based on the user intent, wherein each calculated field includes a name and an associated calculation expression; and validating the one or more calculated fields against the metadata of the database to ensure that each field referenced in each calculation expression exists in the metadata and that each calculation expression conforms to syntax rules defined by the proprietary analytics platform.

Clause 8. The computer-implemented method of any one of clauses 1-7, further comprising: receiving, from the user interface, a subsequent user request; and responsive to the subsequent user request, automatically updating the analytical query to a modified analytical query using the trained artificial intelligence model, comprising: extracting, in runtime, a new user intent from the subsequent user request using natural language processing, wherein the new user intent indicates adding a new filter; updating, in runtime, the intent map to include the new user intent; mapping, in runtime, the new user intent to one or more additional actions using predefined rules stored in the action library, wherein the one or more additional actions define a query operation for adding the new filter; updating, in runtime, the action list based on the one or more additional actions; and constructing, in runtime, the modified analytical query based on the updated action list.

Clause 9. The computer-implemented method of any one of clauses 1-8, wherein automatically generating the analytical query further comprises: identifying, in runtime, based on the user intent, a refinement condition for refining a dataset prior to constructing the analytical query; generating, in runtime, a preliminary query based on the user intent and the metadata of the database, wherein the preliminary query is configured to generate a refined dataset for use in constructing the analytical query; updating, in runtime, the action list to incorporate a reference to the preliminary query as a data source for constructing the analytical query; and validating, in runtime, the analytical query to ensure compliance with syntax rules and metadata constraints of the proprietary analytics platform.

Clause 10. The computer-implemented method of any one of clauses 1-9, further comprising: collecting training data comprising user actions performed through the user interface of the proprietary analytics platform and corresponding query operations, wherein each user action comprises a natural language expression or a user interface interaction and is associated with one or more query operations compatible with the proprietary analytics platform; generating, based on the training data, an action library comprising a plurality of predefined rules that map user intents, derived from the user actions, to corresponding actions, wherein each action defines at least one query operation; and training the artificial intelligence model using the action library as input to learn mappings from user intents to actions.

Clause 11. A computing system comprising: memory; one or more hardware processors coupled to the memory; and one or more non-transitory computer readable storage media storing instructions that, when loaded into the memory, cause the one or more hardware processors to perform operations comprising: receiving, from a user interface of a proprietary analytics platform, a user request in natural language for querying a database; and automatically generating an analytical query using a trained artificial intelligence model, comprising: generating, in runtime, an intent map based on natural language processing of the user request, wherein the intent map comprises a user intent and one or more measures extracted from the user request; enriching, in runtime, the intent map based on metadata of the database, wherein the enriching generates an enriched intent map comprising at least one inferred formula for calculating a measure extracted from the user request; mapping, in runtime, the user intent to an action list based on predefined rules stored in an action library, wherein the action list comprises one or more actions derived from the enriched intent map, wherein the one or more actions define query operations specific to the proprietary analytics platform; and constructing, in runtime, the analytical query based on the action list, wherein execution of the analytical query on the proprietary analytics platform generates an output responsive to the user request based on calculation of the measure using the at least one inferred formula.

Clause 12. The computing system of clause 11, wherein automatically generating the analytical query further comprises: retrieving, in runtime, a user history associated with the user request, wherein the user history comprises one or more historical queries previously generated based on prior user requests; identifying, in runtime, a query refinement related to the user intent from the user history; and refining, in runtime, the action list based on the query refinement, wherein refining the action list comprises adding a new action to the action list or modifying an existing action in the action list, wherein constructing the analytical query is based on the refined action list.

Clause 13. The computing system of any one of clauses 11-12, wherein constructing the analytical query comprises: selecting one or more output fields based on the user intent, wherein the one or more output fields comprise the one or more measures, and further comprise one or more dimensions or one or more calculated columns identified in the action list; and validating the one or more output fields against the metadata of the database to ensure that each output field corresponds to a valid field defined in the metadata.

Clause 14. The computing system of any one of clauses 11-13, wherein constructing the analytical query comprises: applying one or more filters identified in the action list to the analytical query, wherein each filter specifies a field and an associated filter value; and validating the one or more filters against the metadata of the database to ensure that each field specified in the one or more filters exists in the metadata and that each associated filter value conforms to a data type defined in the metadata.

Clause 15. The computing system of any one of clauses 11-14, wherein constructing the analytical query comprises: applying one or more filters identified in the action list to the analytical query, wherein each filter specifies a field and an associated filter value; and validating the one or more filters against the metadata of the database to ensure that each field specified in the one or more filters exists in the metadata and that each associated filter value conforms to a data type defined in the metadata.

Clause 16. The computing system of any one of clauses 11-15, wherein constructing the analytical query comprises: constructing a metric payload comprising the one or more measures identified in the action list, wherein each measure is calculated by a corresponding formula; and validating the metric payload against the metadata of the database to ensure that each field referenced in each corresponding formula exists in the metadata and that each formula conforms to syntax rules defined by the proprietary analytics platform.

Clause 17. The computing system of any one of clauses 11-16, wherein constructing the analytical query comprises: adding one or more calculated fields to the analytical query based on the user intent, wherein each calculated field includes a name and an associated calculation expression; and validating the one or more calculated fields against the metadata of the database to ensure that each field referenced in each calculation expression exists in the metadata and that each calculation expression conforms to syntax rules defined by the proprietary analytics platform.

Clause 18. The computing system of any one of clauses 11-17, wherein the operations further comprise: receiving, from the user interface, a subsequent user request; and responsive to the subsequent user request, automatically updating the analytical query to a modified analytical query using the trained artificial intelligence model, comprising: extracting, in runtime, a new user intent from the subsequent user request using natural language processing, wherein the new user intent indicates adding a new filter; updating, in runtime, the intent map to include the new user intent; mapping, in runtime, the new user intent to one or more additional actions using predefined rules stored in the action library, wherein the one or more additional actions define a query operation for adding the new filter; updating, in runtime, the action list based on the one or more additional actions; and constructing, in runtime, the modified analytical query based on the updated action list.

Clause 19. The computing system of any one of clauses 11-18, wherein automatically generating the analytical query further comprises: identifying, in runtime, based on the user intent, a refinement condition for refining a dataset prior to constructing the analytical query; generating, in runtime, a preliminary query based on the user intent and the metadata of the database, wherein the preliminary query is configured to generate a refined dataset for use in constructing the analytical query; updating, in runtime, the action list to incorporate a reference to the preliminary query as a data source for constructing the analytical query; and validating, in runtime, the analytical query to ensure compliance with syntax rules and metadata constraints of the proprietary analytics platform.

Clause 20. One or more non-transitory computer-readable media having encoded thereon computer-executable instructions causing one or more processors to perform a method, the method comprising: receiving, from a user interface of a proprietary analytics platform, a user request in natural language for querying a database; and automatically generating an analytical query using a trained artificial intelligence model, comprising: generating, in runtime, an intent map based on natural language processing of the user request, wherein the intent map comprises a user intent and one or more measures extracted from the user request; enriching, in runtime, the intent map based on metadata of the database, wherein the enriching generates an enriched intent map comprising at least one inferred formula for calculating a measure extracted from the user request; mapping, in runtime, the user intent to an action list based on predefined rules stored in an action library, wherein the action list comprises one or more actions derived from the enriched intent map, wherein the one or more actions define query operations specific to the proprietary analytics platform; and constructing, in runtime, the analytical query based on the action list, wherein execution of the analytical query on the proprietary analytics platform generates an output responsive to the user request based on calculation of the measure using the at least one inferred formula.

The technologies described from any clause can be combined with the technologies described in any one or more of the other clauses.

In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

1. A computer-implemented method, comprising:
receiving, from a user interface of a proprietary analytics platform, a user request in natural language for querying a database; and
automatically generating an analytical query using a trained artificial intelligence model, comprising:
generating, in runtime, an intent map based on natural language processing of the user request, wherein the intent map comprises a user intent and one or more measures extracted from the user request;
enriching, in runtime, the intent map based on schema of the database, wherein the enriching comprises identifying, from the schema, one or more fields of the database and a calculation rule corresponding to a measure extracted from the user request, generating at least one inferred formula for calculating the measure by applying the calculation rule to the one or more fields, and generating an enriched intent map comprising the at least one inferred formula;
mapping, in runtime, the enriched intent map to an action list based on predefined rules stored in an action library, wherein the action list comprises one or more actions derived from the enriched intent map, wherein the one or more actions define query operations specific to the proprietary analytics platform, and wherein the one or more actions comprise an add-measure action having, as parameters, an identifier of the measure and the at least one inferred formula; and
constructing, in runtime, the analytical query based on the action list, wherein constructing the analytical query comprises translating the add-measure action into a platform-specific metric payload that includes the identifier of the measure and the at least one inferred formula,
wherein execution of the analytical query on the proprietary analytics platform generates an output responsive to the user request based on calculation of the measure using the at least one inferred formula.

2. The computer-implemented method of claim 1, wherein automatically generating the analytical query further comprises:
retrieving, in runtime, a user history associated with the user request, wherein the user history comprises one or more historical queries previously generated based on prior user requests;
identifying, in runtime, a query refinement related to the user intent from the user history; and
refining, in runtime, the action list based on the query refinement, wherein refining the action list comprises adding a new action to the action list or modifying an existing action in the action list,
wherein constructing the analytical query is based on the refined action list.

3. The computer-implemented method of claim 1, wherein constructing the analytical query comprises:
selecting one or more output fields based on the user intent, wherein the one or more output fields comprise the one or more measures, and further comprise one or more dimensions or one or more calculated columns identified in the action list; and
validating the one or more output fields against the schema of the database to ensure that each output field corresponds to a valid field defined in the schema.

4. The computer-implemented method of claim 1, wherein constructing the analytical query comprises:
applying one or more filters identified in the action list to the analytical query, wherein each filter specifies a field and an associated filter value; and
validating the one or more filters against the schema of the database to ensure that each field specified in the one or more filters exists in the schema and that each associated filter value conforms to a data type defined in the schema.

5. The computer-implemented method of claim 1, wherein constructing the analytical query comprises:
defining a grouping plan for the analytical query based on one or more dimensions identified in the action list, wherein the grouping plan specifies an order of the one or more dimensions and an aggregation mode; and
validating the grouping plan against the schema of the database to ensure that each dimension specified in the grouping plan exists in the schema and that the aggregation mode is compatible with the schema.

6. The computer-implemented method of claim 1, wherein constructing the analytical query further comprises:
validating the platform-specific metric payload against the schema of the database to ensure that each field referenced in the at least one inferred formula exists in the schema and that the at least one inferred formula conforms to syntax rules defined by the proprietary analytics platform.

7. The computer-implemented method of claim 1, wherein constructing the analytical query comprises:
adding one or more calculated fields to the analytical query based on the user intent, wherein each calculated field includes a name and an associated calculation expression; and
validating the one or more calculated fields against the schema of the database to ensure that each field referenced in each calculation expression exists in the schema and that each calculation expression conforms to syntax rules defined by the proprietary analytics platform.

8. The computer-implemented method of claim 1, further comprising:
receiving, from the user interface, a subsequent user request; and
responsive to the subsequent user request, automatically updating the analytical query to a modified analytical query using the trained artificial intelligence model, comprising:
extracting, in runtime, a new user intent from the subsequent user request using natural language processing, wherein the new user intent indicates adding a new filter;
updating, in runtime, the intent map to include the new user intent;
mapping, in runtime, the new user intent to one or more additional actions using predefined rules stored in the action library, wherein the one or more additional actions define a query operation for adding the new filter;
updating, in runtime, the action list based on the one or more additional actions; and
constructing, in runtime, the modified analytical query based on the updated action list.

9. The computer-implemented method of claim 1, wherein automatically generating the analytical query further comprises:
identifying, in runtime, based on the user intent, a refinement condition for refining a dataset prior to constructing the analytical query;
generating, in runtime, a preliminary query based on the user intent and the schema of the database, wherein the preliminary query is configured to generate a refined dataset for use in constructing the analytical query;
updating, in runtime, the action list to incorporate a reference to the preliminary query as a data source for constructing the analytical query; and
validating, in runtime, the analytical query to ensure compliance with syntax rules and schema constraints of the proprietary analytics platform.

10. The computer-implemented method of claim 1, further comprising:
collecting training data comprising user actions performed through the user interface of the proprietary analytics platform and corresponding query operations, wherein each user action comprises a natural language expression or a user interface interaction and is associated with one or more query operations compatible with the proprietary analytics platform;
generating, based on the training data, the action library comprising a plurality of predefined rules that map user intents, derived from the user actions, to corresponding actions, wherein each action defines at least one query operation; and
training the artificial intelligence model using the action library as input to learn mappings from user intents to actions.

11. A computing system comprising:
memory;
one or more hardware processors coupled to the memory; and
one or more non-transitory computer readable storage media storing instructions that, when loaded into the memory, cause the one or more hardware processors to perform operations comprising:
receiving, from a user interface of a proprietary analytics platform, a user request in natural language for querying a database; and
automatically generating an analytical query using a trained artificial intelligence model, comprising:
generating, in runtime, an intent map based on natural language processing of the user request, wherein the intent map comprises a user intent and one or more measures extracted from the user request;
enriching, in runtime, the intent map based on schema of the database, wherein the enriching comprises identifying, from the schema, one or more fields of the database and a calculation rule corresponding to a measure extracted from the user request, generating at least one inferred formula for calculating the measure by applying the calculation rule to the one or more fields, and generating an enriched intent map comprising the at least one inferred formula;
mapping, in runtime, the enriched intent map to an action list based on predefined rules stored in an action library, wherein the action list comprises one or more actions derived from the enriched intent map, wherein the one or more actions define query operations specific to the proprietary analytics platform, and wherein the one or more actions comprise an add-measure action having, as parameters, an identifier of the measure and the at least one inferred formula; and
constructing, in runtime, the analytical query based on the action list, wherein constructing the analytical query comprises translating the add-measure action into a platform-specific metric payload that includes the identifier of the measure and the at least one inferred formula,
wherein execution of the analytical query on the proprietary analytics platform generates an output responsive to the user request based on calculation of the measure using the at least one inferred formula.

12. The computing system of claim 11, wherein automatically generating the analytical query further comprises:
retrieving, in runtime, a user history associated with the user request, wherein the user history comprises one or more historical queries previously generated based on prior user requests;
identifying, in runtime, a query refinement related to the user intent from the user history; and
refining, in runtime, the action list based on the query refinement, wherein refining the action list comprises adding a new action to the action list or modifying an existing action in the action list,
wherein constructing the analytical query is based on the refined action list.

13. The computing system of claim 11, wherein constructing the analytical query comprises:
selecting one or more output fields based on the user intent, wherein the one or more output fields comprise the one or more measures, and further comprise one or more dimensions or one or more calculated columns identified in the action list; and
validating the one or more output fields against the schema of the database to ensure that each output field corresponds to a valid field defined in the schema.

14. The computing system of claim 11, wherein constructing the analytical query comprises:
applying one or more filters identified in the action list to the analytical query, wherein each filter specifies a field and an associated filter value; and
validating the one or more filters against the schema of the database to ensure that each field specified in the one or more filters exists in the schema and that each associated filter value conforms to a data type defined in the schema.

15. The computing system of claim 11, wherein constructing the analytical query comprises:
defining a grouping plan for the analytical query based on one or more dimensions identified in the action list, wherein the grouping plan specifies an order of the one or more dimensions and an aggregation mode; and
validating the grouping plan against the schema of the database to ensure that each dimension specified in the grouping plan exists in the schema and that the aggregation mode is compatible with the schema.

16. The computing system of claim 11, wherein constructing the analytical query further comprises:
validating the platform-specific metric payload against the schema of the database to ensure that each field referenced in the at least one inferred formula exists in the schema and that the at least one inferred formula conforms to syntax rules defined by the proprietary analytics platform.

17. The computing system of claim 11, wherein constructing the analytical query comprises:
adding one or more calculated fields to the analytical query based on the user intent, wherein each calculated field includes a name and an associated calculation expression; and
validating the one or more calculated fields against the schema of the database to ensure that each field referenced in each calculation expression exists in the schema and that each calculation expression conforms to syntax rules defined by the proprietary analytics platform.

18. The computing system of claim 11, wherein the operations further comprise:
receiving, from the user interface, a subsequent user request; and
responsive to the subsequent user request, automatically updating the analytical query to a modified analytical query using the trained artificial intelligence model, comprising:
extracting, in runtime, a new user intent from the subsequent user request using natural language processing, wherein the new user intent indicates adding a new filter;
updating, in runtime, the intent map to include the new user intent;
mapping, in runtime, the new user intent to one or more additional actions using predefined rules stored in the action library, wherein the one or more additional actions define a query operation for adding the new filter;
updating, in runtime, the action list based on the one or more additional actions; and
constructing, in runtime, the modified analytical query based on the updated action list.

19. The computing system of claim 11, wherein automatically generating the analytical query further comprises:
identifying, in runtime, based on the user intent, a refinement condition for refining a dataset prior to constructing the analytical query;
generating, in runtime, a preliminary query based on the user intent and the schema of the database, wherein the preliminary query is configured to generate a refined dataset for use in constructing the analytical query;
updating, in runtime, the action list to incorporate a reference to the preliminary query as a data source for constructing the analytical query; and
validating, in runtime, the analytical query to ensure compliance with syntax rules and schema constraints of the proprietary analytics platform.

20. One or more non-transitory computer-readable media having encoded thereon computer-executable instructions causing one or more processors to perform a method, the method comprising:
receiving, from a user interface of a proprietary analytics platform, a user request in natural language for querying a database; and
automatically generating an analytical query using a trained artificial intelligence model, comprising:
generating, in runtime, an intent map based on natural language processing of the user request, wherein the intent map comprises a user intent and one or more measures extracted from the user request;
enriching, in runtime, the intent map based on schema of the database, wherein the enriching comprises identifying, from the schema, one or more fields of the database and a calculation rule corresponding to a measure extracted from the user request, generating at least one inferred formula for calculating the measure by applying the calculation rule to the one or more fields, and generating an enriched intent map comprising the at least one inferred formula;
mapping, in runtime, the enriched intent map to an action list based on predefined rules stored in an action library, wherein the action list comprises one or more actions derived from the enriched intent map, wherein the one or more actions define query operations specific to the proprietary analytics platform, and wherein the one or more actions comprise an add-measure action having, as parameters, an identifier of the measure and the at least one inferred formula; and
constructing, in runtime, the analytical query based on the action list, wherein constructing the analytical query comprises translating the add-measure action into a platform-specific metric payload that includes the identifier of the measure and the at least one inferred formula,
wherein execution of the analytical query on the proprietary analytics platform generates an output responsive to the user request based on calculation of the measure using the at least one inferred formula.
